(19) United States
(12) Patent Application Publication
(10) Pub. No.: US 2022/0162933 A1
(43) Pub. Date: May 26, 2022

(54) SYSTEM FOR HYDRAULIC FRACTURING INCLUDING MOBILE POWER-GENERATING SUBSYSTEM WITH DIRECT-COUPLED GENERATOR

(71) Applicant: Siemens Energy, Inc., Orlando, FL (US)

(72) Inventors: Dalia El Tawy, Houston, TX (US); Arvind Sriraman, Houston, TX (US); Lynn Wheatcraft, Richmond, TX (US)

(21) Appl. No.: 17/439,703

(22) PCT Filed: Jul. 16, 2019
(86) PCT No.: PCT/US2019/041944

§ 371 Date: Sep. 15, 2021

Related U.S. Application Data
(60) Provisional application No. 62/839,104, filed on Apr. 26, 2019.

(51) Int. Cl. E21B 43/26; F02C 6/00

(52) U.S. Cl. CPC E21B 43/2607; F05D 2220/76; F02C 6/00

(57) ABSTRACT

System for hydraulic fracturing is provided. A generator (22) directly coupled to a gas turbine engine (24) without a rotational speed reduction device. Thus, generator (22) may operate at relatively high-speeds and may involve state-of-the art electromotive technologies, such as may include switched reluctance generators (SRG), synchronous reluctance generators (SynRG) or permanent magnet generators (PMG). Power circuitry (30) may be arranged to receive electric power generated by generator (22) and may be electrically connectable to a power bus (32). Gas turbine engine 24), generator (22) and power electronics circuitry (30) may each be respectively mounted onto a power generation mobile platform (34), and in combination constitute a mobile power-generating subsystem (20) that may be operationally arranged in combination with one or more hydraulic fracturing subsystems (50), mobile or otherwise, that can similarly take advantage of such electromotive technologies for motoring purposes.

### CROSS-REFERENCE TO RELATED APPLICATIONS

This application claims benefit of the Apr. 26, 2019 filing date of U.S. provisional application 62/839,104, which is incorporated by reference herein.

### BACKGROUND

### 1. Field

Disclosed embodiments relate generally to the field of hydraulic fracturing, such as used in connection with oil and gas applications, and, more particularly, to a system for hydraulic fracturing, and, even more particularly, to system for hydraulic fracturing including a mobile power-generating subsystem using a direct-coupled generator. That is, a generator mechanically coupled to a gas turbine engine without a rotational speed reduction device.

### 2. Description of the Related Art

Hydraulic fracturing is a process used to foster production from oil and gas wells. Hydraulic fracturing generally involves pumping a high-pressure fluid mixture that may include particles/proppants and optional chemicals at high pressure through the wellbore into a geological formation. As the high-pressure fluid mixture enters the formation, this fluid fractures the formation and creates fissures. When the fluid pressure is released from the wellbore and formation, the fractures or fissures settle, but are at least partially held open by the particles/proppants carried in the fluid mixture. Holding the fractures open allows for the extraction of oil and gas from the formation.

Certain known hydraulic fracturing systems may use large diesel engine-powered pumps to pressurize the fluid mixture being injected into the wellbore and formation. These large diesel engine-powered pumps may be difficult to transport from site to site due to their size and weight, and are equally—if not more—difficult to move or position in a remote and undeveloped wellsite, where paved roads and space to maneuver may not be readily available. Further, these large diesel engine powered pumps require large fuel storage tanks, which must also be transported to the wellsite. Another drawback of systems involving diesel engine-powered pumps is the burdensome maintenance requirements of diesel engines, which generally involve significant maintenance operations approximately every 300-400 hours, thus resulting in regular downtime of the engines approximately every 2-3 weeks. Moreover, the power-to-weight ratio of prior art mobile systems involving diesel engine-powered pumps tends to be relatively low.

To try to alleviate some of the difficulties involved with diesel engine-powered fracturing pump systems, certain electrically-driven hydraulic fracturing systems have been proposed. For an example of one approach involving an electric hydraulic system, see International Publication WO 2018/071738 A1.

### BRIEF DESCRIPTION

A disclosed embodiment is directed to a system for hydraulic fracturing. The system may include a gas turbine engine, a generator directly coupled to the gas turbine engine without a rotational speed reduction device, and power circuitry arranged to receive electric power generated by the generator and electrically connectable to a power bus. The gas turbine engine, the generator and the power electronics circuitry may each be respectively mounted onto a power generation mobile platform, and in combination constitute a mobile power-generating subsystem.

### BRIEF DESCRIPTION OF THE DRAWINGS

FIG. 1 illustrates a block diagram of one non-limiting embodiment of a disclosed mobile power-generating subsystem that may involve a generator directly coupled to a gas turbine engine without a rotational speed reduction device.

FIG. 2 illustrates a block diagram of one non-limiting embodiment of a disclosed system, where the generator in the mobile power-generating subsystem may be a switched reluctance generator; and further illustrates one non-limiting example of a disclosed hydraulic fracturing subsystem, mobile or otherwise, which may be operationally arranged in combination with the mobile power-generating subsystem.

FIG. 3 illustrates a block diagram of another non-limiting embodiment of a disclosed system, where the mobile power-generating subsystem may be as illustrated in FIG. 2; and further illustrates another non-limiting example of a disclosed hydraulic fracturing subsystem, mobile or otherwise.

FIG. 4 illustrates a block diagram of one non-limiting embodiment of a disclosed system, where the generator in the power-generating subsystem may be a permanent magnet generator; and further illustrates yet another non-limiting example of a hydraulic fracturing subsystem, mobile or otherwise.

FIG. 5 illustrates a block diagram of one non-limiting embodiment of a disclosed system that may involve a scalable, hydraulic fracturing system involving disclosed hydraulic fracturing subsystem as building blocks, and may further involve a scalable, power-generating system involving disclosed power-generating subsystems as building blocks.

### DETAILED DESCRIPTION

The present inventors have recognized that certain prior art systems for hydraulic fracturing may involve a gas turbine engine mechanically connected to rotate a synchronous generator via a speed reduction gearbox. For example, the rated rotational speed of the gas turbine engine may vary within a range from approximately 6000 revolutions per minute (rpm) to approximately 14000 rpm, and the rated rotational speed of the generators may vary from approximately 1000 rpm to approximately 3000 rpm.

The present inventors have further recognized that these prior art systems involving gearboxes may suffer from certain drawbacks. For example, the gearboxes may need costly overhauling several times during their respective lifetimes, and may further need periodic servicing of, for example, their substantially complicated lubrication subsystems. For example, the multiple wheels and bearings that may be involved in a gearbox may be operational subject to high levels of stress, and a malfunction of even a single component in the gearbox can potentially bring power generation to a halt, and in turn can result in a substantially costly event (e.g., loss of a well) in a hydraulic fracturing application. This makes the gearbox a relatively high-maintenance part of these prior art systems. Lastly, the prices of the gearboxes can almost equal the prices of the relatively heavy and bulky generators typically involved in these prior art systems.

At least in view of such recognition, disclosed embodiments formulate an innovative approach in connection with systems for hydraulic fracturing. This approach effectively removes the gearbox from the turbomachinery involved, thus eliminating a technically complicated component of the system, and therefore improving an overall reliability of the system.

Without limitation, disclosed embodiments can take advantage of high-speed, direct-drive generators that may involve state-of-the art electromotive technologies, such as may include switched reluctance generators (SRG), synchronous reluctance generators (SynRG), permanent magnet generators (PMG), synchronous induction generators made of light-weight materials and other technologies, which allow the generator rotor to reliably rotate at relatively higher speeds compared to the standard generator rotation speed traditional involved in power generation applications, such as in the order of approximately 10 MW, thereby allowing the generator to be directly coupled to a high-speed rotating gas turbine engine, such as may involve rotational speeds in the order of approximately 14000 rpm and higher.

Disclosed embodiments of direct coupled turbo-machinery equipment allow integrating an entire power generation subsystem in a relatively compact and lighter assembly, which is more attractive for mobile applications. For example, more suitable for the limited footprint that may be available in mobile hydraulic fracturing applications.

Non-limiting technical features of high-speed generators that may be used in disclosed embodiments may include designs involving a relatively higher number of rotor/stator poles, advanced bearing technologies, such as magnetic bearing, and single core or multiple cores on a common rotor shaft for multiple voltage level generation. Depending on the needs of a given application, topologies of disclosed embodiments could be adapted to generate alternating current (AC) power or direct current (DC) power. Moreover, such topologies may be optimized to reduce system harmonics, especially in the case of generated DC power (as with an SRG).

Depending on the nature of the generated power, circuit topologies may include AC-DC-AC power conversion, DC-DC, or DC-AC conversion, such as may involve inverter-based variable frequency drives (VFD) or a switched reluctance drive (SRD), such as in embodiments where a switched reluctance motor (SRM) is utilized. As suggested above, advantages obtained from state-of-the-art electromotive technologies may be extended to the electric motors driving the utilization loads, such as one or more hydraulic fracturing pumps. These electric motors can equally benefit from such electromotive technologies, such as including state-of-the-art induction motor technology, switched reluctance motor technology, synchronous reluctance motor technology, or permanent magnet motor technology.

In the following detailed description, various specific details are set forth in order to provide a thorough understanding of such embodiments. However, those skilled in the art will understand that disclosed embodiments may be practiced without these specific details that the aspects of the present invention are not limited to the disclosed embodiments, and that aspects of the present invention may be practiced in a variety of alternative embodiments. In other instances, methods, procedures, and components, which would be well-understood by one skilled in the art have not been described in detail to avoid unnecessary and burdensome explanation.

Furthermore, various operations may be described as multiple discrete steps performed in a manner that is helpful for understanding embodiments of the present invention. However, the order of description should not be construed as to imply that these operations need be performed in the order they are presented, nor that they are even order dependent, unless otherwise indicated. Moreover, repeated usage of the phrase “in one embodiment” does not necessarily refer to the same embodiment, although it may. It is noted that disclosed embodiments need not be construed as mutually exclusive embodiments, since aspects of such disclosed embodiments may be appropriately combined by one skilled in the art depending on the needs of a given application.

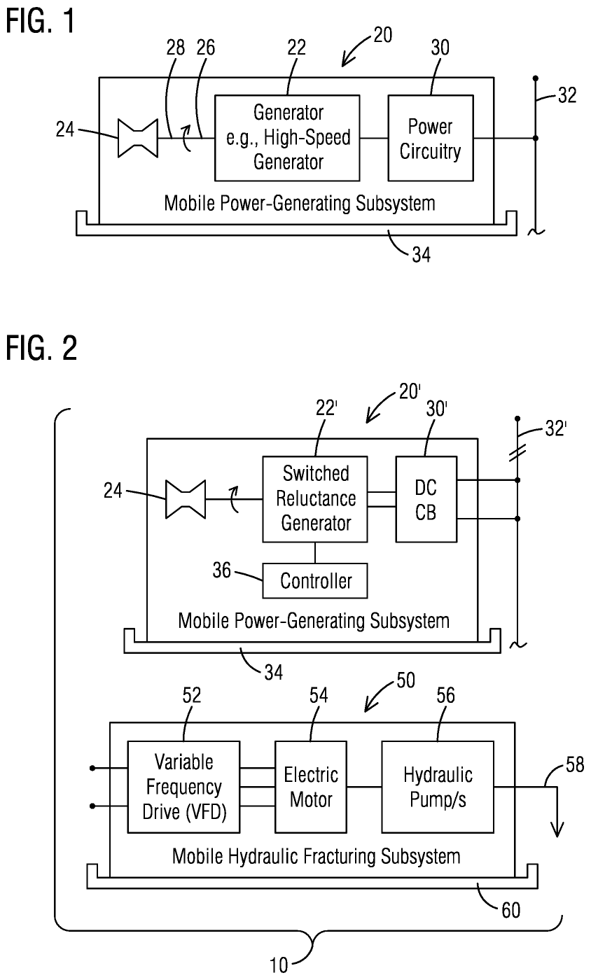

FIG. 1 illustrates a block diagram of one non-limiting embodiment of a disclosed mobile power-generating subsystem 20 that may involve a generator 22, such as without limitation, having a rotor shaft 26 coupled to a main shaft 28 of a gas turbine engine 24 without a rotational speed reduction device. Without limitation, this structural and/or operational relationship may be referred to in the art as involving a high-speed generator; a direct-coupled generator; a direct-drive generator or a gearless-coupled generator.

In one non-limiting embodiment, power circuitry 30 may be arranged to receive electric power generated by generator 22. As described in greater detail below, power circuitry 30 may be electrically connectable to a power bus 32. In one non-limiting embodiment, gas turbine engine 24, generator 22 and power circuitry 30 may each be respectively mounted onto a respective mobile power generation platform 34 (e.g., a singular mobile platform) that can propel itself (e.g., a self-propelled mobile platform); or can be towed or otherwise transported by a self-propelled vehicle and effectively form a self-contained, mobile power-generating system. It will be appreciated that this self-contained, mobile hybrid power-generating subsystem may operate fully independent from utility power or any external power sources.

That is, each of the foregoing components of mobile power-generating subsystem 20 may be respectively mounted onto mobile power generation platform 34 so that mobile power-generating subsystem 20 is transportable from one physical location to another. For example, mobile power generation platform 34 may represent a self-propelled vehicle alone, or in combination with a non-motorized cargo carrier (e.g., semi-trailer, full-trailer, dolly, skid, barge, etc.) with the subsystem components disposed onboard the self-propelled vehicle and/or the non-motorized cargo carrier. As suggested above, mobile power generation platform 34 need not be limited to land-based transportation and may include other transportation modalities, such as rail transportation, marine transportation, etc.

In one non-limiting embodiment, gas turbine engine 24 may be (but need not be) an aeroderivative gas turbine engine, such as model SGT-A05 aeroderivative gas turbine engine available from Siemens. There are several advantages of aero-derivative gas turbines that may be particularly beneficial in a mobile fracturing application. Without limitation, an aero-derivative gas turbine is relatively lighter in weight and relatively more compact than an equivalent industrial gas turbine, which are favorable attributes in a mobile fracturing application. Depending on the needs of a given application, another non-limiting example of gas turbine engine 24 may be model SGT-300 industrial gas turbine engine available from Siemens. It will be appreciated that disclosed embodiments are not limited to any specific model or type of gas turbine engine.

FIG. 2 illustrates a block diagram of one non-limiting embodiment of a disclosed system 10 for hydraulic fracturing, such as may involve a mobile power-generating subsystem 20′ and a mobile hydraulic fracturing subsystem 50. In one non-limiting embodiment, the generator (e.g., the high-speed, direct-drive generator) in mobile power-generating subsystem 20′, without limitation, may be a switched reluctance generator 22′ that may be controlled by a controller 36 using standard control techniques that would be readily within the scope of knowledge of one skilled in the art.

Without limitation, in this non-limiting embodiment, the generated electric power may be DC power and the power circuitry may comprise a DC circuit breaker (CB) 30′ arranged to receive the DC power generated by switched reluctance generator 22′. In this non-limiting embodiment, the power bus to which DC power circuit breaker 30′ may be electrically connectable would a DC power bus 32′. One non-limiting example of DC circuit breaker 30′ that may be used may be Sitras® DC switchgear available from Siemens. It will be appreciated that disclosed embodiments are not limited to any specific model of DC circuit breaker 30′.

The attractiveness of switched reluctance machinery, particularly when operating in a motoring mode is well-documented in the technical literature; less so when such machinery is operating in a generating mode. However, due to its geometric simplicity and advantages, such as robustness, ability to operate over a wide speed range and absence of permanent magnets and windings on the rotor, a switched reluctance generators (SRG) is believed to provide a particularly promising development for hydraulic fracturing applications.

The following are-non-limiting examples of attractive characteristics of a SRG that have been recognized by Applicant as effective to realizing novel technical solutions by disclosed embodiment for hydraulic fracturing applications:
Substantially high power-to-weight ratio;
Straightforward construction, such as rotor construction of laminated steel, without permanent magnets or windings;
High efficiency over a wide speed range;
Can reliably operate at high-speeds and high-temperatures since, for example, the rotor can act as a cooling source to the stator;
Relatively high reliability since, for example, each phase is electrically and magnetically independent from one another.

For readers desirous of further background information, see for example, technical paper titled “State of the Art of Switched Reluctance Generator”, by A. Arifin, I. Al-Bahadly, S. C. Mukhopadhyay, published by Energy and Power Engineering, 2012, 4, 447-458, Copyright © 2012 Scientific Research.

The description below will now proceed to describe components illustrated in FIG. 2 that may be used in hydraulic fracturing subsystem 50. In this non-limiting embodiment, a variable frequency drive (VFD) 52 may be electrically coupled to receive power from DC power bus 32′. VFD 52 may have a modular construction that may be adapted based on the needs of a given application. For example, since in this embodiment VFD 52 is connected to DC power bus 32′, VFD would not include a power rectifier module.

An electric motor 54, such as without limitation, an induction motor, a permanent magnet motor, or a synchronous reluctance motor, may be electrically driven by VFD 52. One or more hydraulic pumps 56 may be driven by electric motor 54 to deliver a pressurized fracturing fluid, (schematically represented by arrow 58), such as may be conveyed to a well head to be conveyed through the wellbore of the well into a given geological formation. As noted above, the modular construction of VFD 52 may allow to selectively scale the output power of VFD 52 based on the power ratings of electric motor 54 and in turn based on the ratings of the one or more hydraulic pumps 56 driven by electric motor 54.

As will be appreciated by one skilled in the art, techniques involving variable speed operation of an electric motor, in addition to the term VFD, may also be referred to in the art as variable speed drive (VSD); or variable voltage, variable frequency (VVVF). Accordingly, without limitation, any of such initialisms or phrases may be interchangeably applied in the context of the present disclosure to refer to drive circuitry that may be used in disclosed embodiments for variable speed operation of an electric motor.

In one non-limiting embodiment, VFD 52, electric motor 54, and hydraulic pump/s 56 may be arranged on a respective mobile platform 60 (e.g., a singular mobile platform). That is, each of such subsystem components may be respectively mounted onto respective mobile platform 60. Structural and/or operational features of mobile platform 60 may be as described above in the context of mobile power generation platform 34. Accordingly, mobile hydraulic fracturing subsystem 50 may be transportable from one physical location to another.

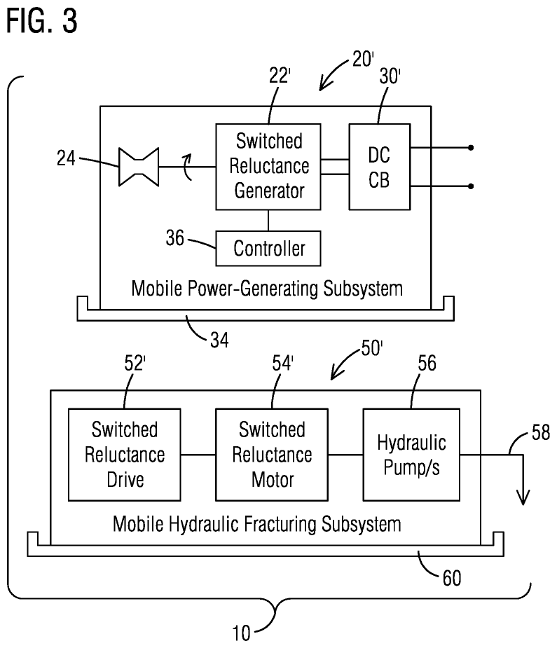

FIG. 3 illustrates a block diagram of another non-limiting embodiment of a disclosed system 10, where mobile power-generating subsystem 20′, as described above in the context of FIG. 2, is operationally arranged in combination with another non-limiting example of a disclosed mobile hydraulic fracturing subsystem 50′.

The description below will now proceed to describe components that may be used in mobile hydraulic fracturing subsystem 50′. In this non-limiting embodiment, a switched reluctance drive (SRD) 52′ may be electrically coupled to receive power from DC bus 32′. A switched reluctance motor (SRM) 54′, may be electrically driven by SRD 52′. Hydraulic pump's 56 may be driven by SRM 54′ to deliver pressurized fracturing fluid 58, as noted above. In one non-limiting embodiment, SRD 52′, SRM 54′, and hydraulic pump/s 56 may be arranged onto singular mobile platform 60. That is, each of such subsystem components may be respectively mounted onto mobile platform 60 to form mobile hydraulic fracturing subsystem 50′.

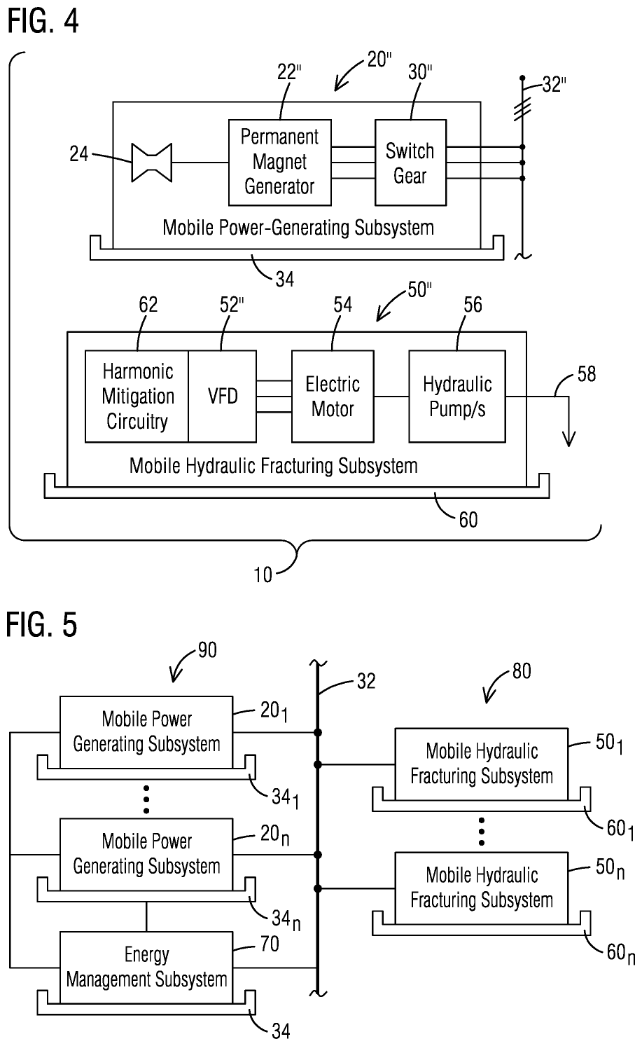

FIG. 4 illustrates a block diagram of yet another non-limiting embodiment of a disclosed system 10 for hydraulic fracturing, such as may involve a mobile power-generating subsystem 20″ and a mobile hydraulic fracturing subsystem 50″. In one non-limiting embodiment, the generator (e.g., the high-speed, direct-drive generator) in mobile power-generating subsystem 20″, without limitation, may be a permanent magnet (PM) generator 22″.

Without limitation, in this non-limiting embodiment, the electric power generated by P.M. generator 22″ may be alternating current (AC) power and the power circuitry may comprise AC switchgear 30″ arranged to receive the AC power generated by PM generator 22. In this non-limiting embodiment, the power bus to which switchgear 30″ may be electrically connectable would be an AC power bus 32″.

In this non-limiting embodiment, a variable frequency drive (VFD) 52″ may be electrically coupled to receive power from AC power bus 32″. In this embodiment, VFD 52″ being connected to AC power bus 32″, would include a power rectifier module. In one non-limiting embodiment, VFD 52″ may comprise a six-pulse VFD. That is, VFD 52″ may be constructed with power switching circuitry arranged to form six-pulse sinusoidal waveforms. As will be appreciated by one skilled in the art, such VFD topology, offers at a lower cost, a relatively more compact and lighter topology than VFD topologies involving a higher number of pulses, such as 12-pulse VFDs, 18-pulse VFDs, etc.

One non-limiting example of VFDs that may be used in disclosed embodiments may be a drive appropriately selected—based on the needs of a given hydraulic fracturing application—from the Sinamics portfolio of VFDs available from Siemens. It will be appreciated that disclosed embodiments are not limited to any specific model of VFDs.

For example, without limitation, one may use sturdy and ruggedized VFDs that have proven to be highly reliable, for example, in the challenging environment of mining applications or similar, and, consequently, are expected to be equally effective in the challenging environment of hydraulic fracturing applications. In one non-limiting embodiment, as indicated in FIG. 4, harmonic mitigation circuitry 62, such as may involve a line reactor may be used to, for example, reduce harmonic waveforms drawn from generator 22″.

Electric motor 54—as noted above may be without limitation, an induction motor, a permanent magnet motor, or a synchronous reluctance motor,—may be electrically driven by VFD 52″ and in turn electric motor 54 would drive hydraulic pump/s 56 to deliver the pressurized fracturing fluid.

FIG. 5 illustrates a block diagram of one non-limiting embodiment of a disclosed system that may involve a scalable, mobile hydraulic fracturing system 80 using two or more of mobile hydraulic fracturing subsystems (e.g., 50₁ through 50ₙ) as building blocks. Presuming, for the sake of illustrative purposes, mobile hydraulic fracturing system 80 is made up of mobile hydraulic fracturing subsystems 50 (FIG. 2), then a further mobile hydraulic fracturing subsystem 50₁ would include a further VFD 52, a further electric motor 54, and further hydraulic pump/s 56, arranged on a further mobile platform 60₁.

Alternatively, presuming mobile hydraulic fracturing system 80 is made up of mobile hydraulic fracturing subsystems 50′ (FIG. 3), then a further mobile hydraulic fracturing subsystem 50₁ would include a further SRD 52′, a further SRM 54′, and further hydraulic pump/s 36, arranged on further mobile platform 60₁. It will be appreciated that the total number of mobile hydraulic fracturing subsystems that may be arranged to form mobile hydraulic fracturing system 80 may be tailored based on the needs of a given application.

As further illustrated in FIG. 5, this non-limiting embodiment may further involve a scalable, micro-grid power-generating system 90 using two or more of mobile power-generating subsystems (20₁ through 20ₙ) as building blocks. Presuming, for the sake of illustrative purposes, scalable, micro-grid power-generating system 90 is made up of mobile power-generating subsystems 20′ (FIG. 2), then a further power-generating subsystem 20₁ would include a further gas turbine engine 24, a further switched reluctance generator 22′ and controller, and a further DC circuit breaker 30′ arranged on a further mobile power generation platform 34₁.

Alternatively, presuming micro-grid power-generating system 90 is made up of mobile power-generating subsystems 20″ (FIG. 4); then a further power-generating subsystem would include a further gas turbine engine 24, a further PM generator 22″, and further switchgear 30″ arranged on a further mobile power generation platform 34₁. In this example, power bus 32 would be an AC power bus and scalable, mobile hydraulic fracturing system 80 would be made up of hydraulic fracturing subsystems suitable for such AC power bus. Regardless of the specific implementation, the total number of mobile power-generating subsystems that may be arranged to form micro-grid power-generating system 90 may be tailored based on the needs of a given application.

An energy management subsystem 70 may be configured to execute a power control strategy configured to optimize utilization of power generated by mobile power-generating subsystems 20₁ through 20ₙ to meet variable power demands of the mobile hydraulic fracturing subsystems connected to power bus 32.

In operation, disclosed embodiments are believed to cost-effectively and reliably provide technical solutions that effectively remove gearboxes typically involved in prior art implementation, thus eliminating a technically complicated component of prior art implementations, and therefore improving an overall reliability of disclosed systems. Without limitation, this may be achieved by way of cost-effective utilization of relatively compact, and light-weight electromotive machinery and drive circuitry.

In operation, disclosed embodiments can also offer a compact and self-contained, mobile power-generating system that may be configured with smart algorithms to prioritize and determine power source allocation for optimization conducive to maximize the reliability and durability of the power sources involved while meeting the variable power demands of loads that may be involved in the hydraulic fracturing process.

While embodiments of the present disclosure have been disclosed in exemplary forms, it will be apparent to those skilled in the art that many modifications, additions, and deletions can be made therein without departing from the scope of the invention and its equivalents, as set forth in the following claims.

1. A system for hydraulic fracturing, the system comprising:
a gas turbine engine;
a generator directly coupled to the gas turbine engine without a rotational speed reduction device; and
power circuitry arranged to receive electric power generated by the generator and electrically connectable to a power bus,
wherein the gas turbine engine, the generator and the power circuitry is each respectively mounted onto a power generation mobile platform, and in combination constitute a mobile power-generating subsystem.

2. The system of claim 1, wherein the generator comprises a switched reluctance generator and the generated electric power comprises direct current (DC) power.

3. The system of claim 1, wherein the power circuitry arranged to receive the DC power generated by the switched reluctance generator comprises a DC power circuit breaker, and wherein the power bus comprises a DC power bus.

4. The system of claim 3, further comprising a mobile hydraulic fracturing subsystem comprising:
a switched reluctance drive electrically coupled to the DC power bus;
a switched reluctance motor electrically driven by the switched reluctance drive; and
a hydraulic pump driven by the switched reluctance drive, the hydraulic pump arranged to deliver a pressurized fracturing fluid,
wherein the switched reluctance drive, the switched reluctance motor, and the hydraulic pump being arranged on a mobile platform.

5. The system of claim 3, further comprising a mobile hydraulic fracturing subsystem comprising:
a variable frequency drive electrically coupled to the DC power bus;
an electric motor electrically driven by the variable frequency drive; and
a hydraulic pump driven by the electric motor, the hydraulic pump arranged to deliver a pressurized fracturing fluid,
wherein the variable frequency drive, the electric motor, and the hydraulic pump being arranged on a mobile platform.

6. The system of claim 5, wherein the electric motor is selected from the group consisting of an induction motor, a permanent magnet motor, and a synchronous reluctance motor.

7. The system of claim 1, wherein the generator comprises a permanent magnet generator and the generated electric power comprises alternating current (AC) power.

8. The system of claim 7, wherein the power circuitry arranged to receive the AC power generated by the permanent magnet generator comprises switchgear circuitry.

9. The system of claim 8, further comprising a mobile hydraulic fracturing sub system comprising:
a variable frequency drive electrically coupled to the AC power bus;
an electric motor electrically driven by the variable frequency drive; and
a hydraulic pump driven by the electric motor, the hydraulic pump arranged to deliver a pressurized fracturing fluid,
wherein the variable frequency drive, the electric motor, and the hydraulic pump being arranged on a mobile platform.

10. The system of claim 9, wherein the variable frequency drive comprises a six-pulse variable frequency drive.

11. The system of claim 10, wherein the six-pulse variable frequency drive includes harmonic mitigation circuitry.

12. The system of claim 5, wherein the electric motor is selected from the group consisting of an induction motor, a permanent magnet motor, and a synchronous reluctance motor.

13. The system of claim 1, wherein the power bus is arranged to form a scalable, mobile micro-grid power-generating system in combination with at least a further one of the mobile power-generating subsystem, each of the at least further one of the mobile power-generating subsystem comprising a further generator, a further gas turbine engine and further power circuitry arranged on a further power generation semi-trailer.

14. The system of claim 4, wherein the switched reluctance drive, the switched reluctance motor, and the hydraulic pump being arranged on the mobile platform constitutes a mobile hydraulic fracturing subsystem that may be arranged with at least one further mobile hydraulic fracturing subsystem to form a scalable mobile hydraulic fracturing system, each of the least one further mobile hydraulic fracturing subsystem comprising a further switched reluctance drive, a further switched reluctance motor, and a further hydraulic pump being arranged on a further mobile platform.

15. The system of claim 5, wherein the variable frequency drive, the electric motor, and the hydraulic pump being arranged on the mobile platform constitutes a mobile hydraulic fracturing subsystem that may be arranged with at least one further mobile hydraulic fracturing subsystem to form a scalable mobile hydraulic fracturing system, each of the least one further mobile hydraulic fracturing subsystem comprising a further variable frequency drive, a further electric motor, and a further hydraulic pump being arranged on a further mobile platform.
